(19) United States
(12) Patent Application Publication
(10) Pub. No.: US 2017/0366278 A1
(43) Pub. Date: Dec. 21, 2017

(54) UNDERWATER BI-DIRECTIONAL WIRELESS IMAGE DATA COMMUNICATION SYSTEM BASED ON ILLUMINATION DIFFUSION SUPPORT

(71) Applicant: KIMIN ELECTRONIC CO., LTD., Gumi-si (KR)

(72) Inventor: Se-Bong Jang, Gumi-si (KR)

(73) Assignee: KIMIN ELECTRONIC CO., LTD.

(21) Appl. No.: 15/345,740

(22) Filed: Nov. 8, 2016

(30) Foreign Application Priority Data
Jun. 16, 2016 (KR) 10-2016-0074930

(51) Int. Cl. H04B 10/80; H04B 10/40

(52) U.S. Cl. CPC H04B 10/80; H04B 10/40

(57) ABSTRACT

An underwater bi-directional wireless image data communication system includes a wireless image communication device having a comparison processing device for converting an image signal about image data from an image device into an electrical signal, a light emitting unit for receiving the electrical signal from the comparison processing device and converting the electrical signal into an optical signal to output light, and a light receiving unit for receiving an external optical signal and converting the external optical signal into an electrical signal to be output as an image, and an illumination diffusion device for providing illumination having higher intensity than illumination of the light emitting unit to a communication area between wireless image communication devices when underwater bi-directional wireless communication is performed using the wireless image communication devices.

### REFERENCE TO RELATED APPLICATIONS

This application is based upon and claims the priority benefit of Korean Patent Application No. 10-2016-0074930 filed on Jun. 16, 2016, the entire contents of which are incorporated herein by reference.

### FIELD OF THE INVENTION

The present invention relates to an underwater bi-directional wireless image data communication system based on illumination diffusion support, and more particularly to an underwater bi-directional wireless image data communication system based on illumination diffusion support that is capable of supporting illumination diffusion based on a minute change in luminous intensity of diffused light in the state in which underwater turbidity is high, thereby efficiently achieving wireless communication of image data under the water.

### BACKGROUND OF THE INVENTION

In general, visible light communication is a kind of communication system that wirelessly transmits and receives data using the wavelength of visible light emitted from a light emitting diode (LED) while maintaining an illumination function of the light emitting diode.

Visible light communication technology is different from wired optical communication technology and infrared wireless communication in that light in a visible light wavelength band (380 to 780 nm) is used in the visible light communication technology. Moreover, the visible light communication technology is different from wired optical communication technology in that communication is wirelessly performed in the visible light communication technology.

In addition, in the visible light communication technology, frequencies are freely usable without regulation or permission, unlike radio frequency (RF) wireless communication. That is, convenience is very high. Furthermore, physical security is excellent, and it is possible for users to check communication links with their own eyes. Above all, visible light communication technology is characterized as convergent technology that is capable of realizing a communication function of light in addition to an inherent function of the light.

Visible light communication is mainly used for high-speed communication by maintaining focus of transmitting and receiving units based on coupling between complicated optical systems, i.e. through a field of view (FOV) or a line of sight (LOS).

In the conventional visible light communication, however, the luminous intensity of light is lowered as the result of controlling current flowing in the LED, with the result that an illumination function is deteriorated. In addition, it is difficult to perform long-distance data communication with a device including a transmission unit having a low luminous intensity. For a charge-coupled device (CCD), the frame rate, which is critical for acquisition of image data, is low, with the result that it is difficult to use the CCD.

In order to solve the above problems, Korean Registered Patent No. 10-1247901 (Mar. 20, 2013) discloses a data transmission device using visible light, which includes a light emitting unit including a plurality of light sources for transmitting an optical signal having a visible light wavelength band, a storage unit for storing binary data to be transmitted, and a controller for selecting a pulse width modulation (PWM) dimming mode or an analog dimming mode for each time interval preset in response to the binary data stored in the storage unit and controlling the light sources based on the selected dimming mode, whereby it is possible to reduce the incidence of errors during data communication using the light sources while deteriorating an illumination function.

In the conventional visible light communication technology, however, transmitted light and received light are scattered during underwater communication, particularly during underwater data communication in the state in which underwater turbidity is high. As a result, normal data communication is not possible. Furthermore, frequent errors may be generated.

### SUMMARY OF THE INVENTION

Therefore, the present invention has been made in view of the above problems, and it is an object of the present invention to provide an underwater bi-directional wireless image data communication system based on illumination diffusion support that is capable of providing illumination diffusion in order to increase the luminous intensity of an optical signal, which is low when underwater turbidity is high, thereby achieving the linearity of a light reception signal, which is low under the water, thus performing underwater image data communication based on excellent-quality bandwidth.

In accordance with the present invention, the above and other objects can be accomplished by the provision of an underwater bi-directional wireless image data communication system including a wireless image communication device including a comparison processing device for converting an image signal about image data photographed by an image device or input from the image device into an electrical signal, a light emitting unit for receiving the electrical signal from the comparison processing device and converting the electrical signal into an optical signal to output light, and a light receiving unit for receiving an external optical signal and converting the external optical signal into an electrical signal to be output as an image, and an illumination diffusion device for providing illumination having higher intensity than the illumination of the light emitting unit to a communication area between wireless image communication devices when underwater bi-directional wireless communication is performed using the wireless image communication devices.

The wireless image communication device may be provided separately from the image device. In this case, the wireless image communication device may include an integrated image port, which is connected to an external image device such that an image signal is input to the wireless image communication device through the integrated image port. Alternatively, the wireless image communication device may be integrated with the image device. In this case, the wireless image communication device may include a photographing module connected to the comparison processing device for photographing an image.

The wireless image communication device may include an image display device for receiving the electrical signal, which has been received and converted by the light receiving unit and outputting the image received by the light receiving unit.

The image display device may be integrated with the wireless image communication device or may be provided separately from the wireless image communication device.

The light emitting unit may include a light emission processor for converting a series-type electrical signal output from the comparison processing device into a single-wavelength optical signal and transmitting the optical signal.

In addition, the wireless image communication device may further include a signal controller for, when the light receiving unit receives an optical signal during underwater bi-directional wireless communication, controlling the light emitting unit to output an optical signal indicating that the optical signal has been received to another wireless image communication device.

When, after the light emitting unit transmits an optical signal to the another wireless image communication device, the wireless image communication device does not receive an optical signal indicating that the optical signal has been received from the another wireless image communication device, the signal controller may control the light emitting unit to output an optical signal for illumination adjustment to the illumination diffusion device.

The underwater bi-directional wireless image data communication system may further include a turbidity measurement unit mounted to the illumination diffusion device for measuring underwater turbidity, wherein the illumination diffusion device may include an illumination adjustment unit for adjusting the intensity of illumination based on the underwater turbidity measured by the turbidity measurement unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically showing the construction of an embodiment of the present invention;

FIG. 2 is a block diagram schematically showing the embodiment of the present invention;

FIG. 3 is a block diagram schematically showing another embodiment of the present invention; and

FIG. 4 is a block diagram schematically showing a further embodiment of the present invention.

### DETAILED DESCRIPTION OF THE INVENTION

The present invention is characterized by an underwater bi-directional wireless image data communication system based on illumination diffusion support including a wireless image communication device including a comparison processing device for converting an image signal about image data photographed by an image device or input from the image device into an electrical signal, a light emitting unit for receiving the electrical signal from the comparison processing device and converting the electrical signal into an optical signal to output light, and a light receiving unit for receiving an external optical signal and converting the external optical signal into an electrical signal to be output as an image, and an illumination diffusion device for providing illumination having higher intensity than the illumination of the light emitting unit to a communication area between wireless image communication devices when underwater bi-directional wireless communication is performed using the wireless image communication devices.

Hereinafter, exemplary embodiments of the underwater bi-directional wireless image data communication system based on illumination diffusion support according to the present invention will be described in detail with reference to the accompanying drawings.

However, the present invention may be modified in various forms, and therefore the present invention is not limited to embodiments, which will be described in detail. The embodiments of the present invention are presented to enable any person of ordinary skill in the art to make and practice the present invention. The shapes of elements shown in the drawings are illustrated to more clearly describe the present invention.

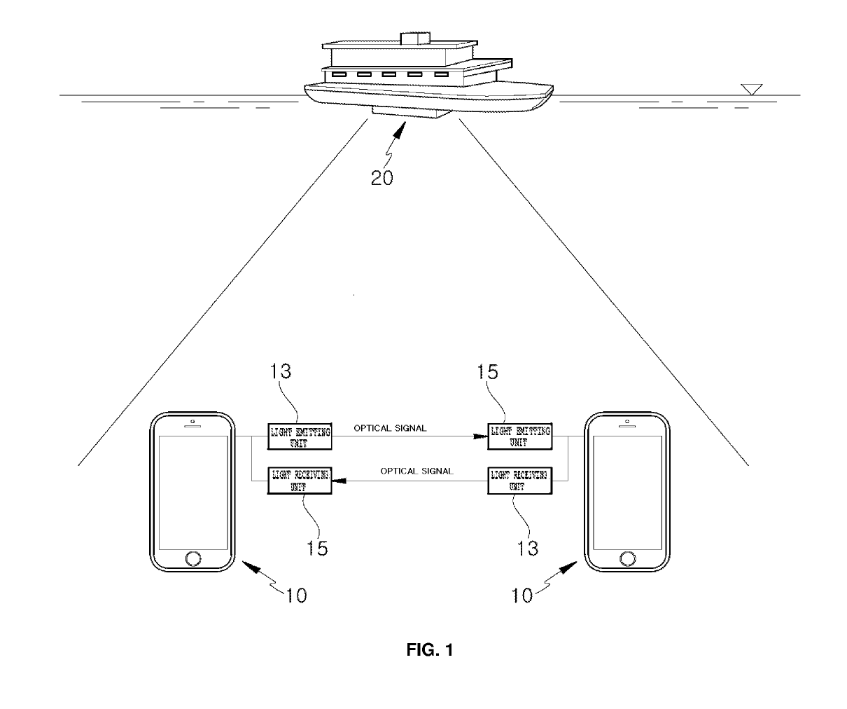

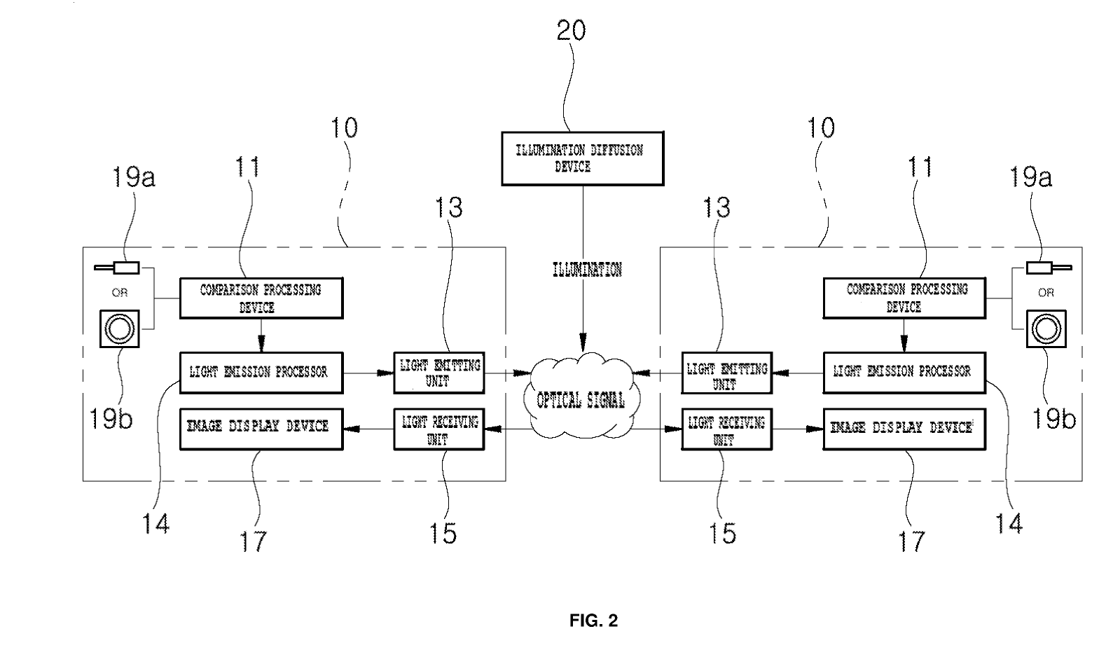

Referring first to FIGS. 1 and 2, an embodiment of the underwater bi-directional wireless image data communication system based on illumination diffusion support according to the present invention includes a wireless image communication device 10 and an illumination diffusion device 20.

The wireless image communication device 10 performs a function of wirelessly communicating image data through underwater visible light communication.

In general, visible light communication is mainly used for high-speed communication by maintaining focus of transmitting and receiving units based on coupling between complicated optical systems, i.e. through a field of view (FOV) or a line of sight (LOS).

As shown in FIG. 2, the wireless image communication device 10 includes a comparison processing device 11 for converting an image signal into an electrical signal, a light emitting unit 13 for converting an electrical signal into an optical signal, and a light receiving unit 15 for converting an optical signal into an electrical signal.

In the figure, the wireless image communication device 10 is incorporated into a mobile communication terminal. However, the present invention is not limited thereto. For example, the wireless image communication device 10 may be a modularized device that is provided separately from the mobile communication terminal.

The comparison processing device 11 is connected to a terminal to which image data are input from an image device to convert an image signal about the image data, which have been photographed by the image device or have been input from the image device, into an electrical signal.

The image device may be provided separately from the wireless image communication device 10, or may be integrated into the wireless image communication device 10.

In the case in which the wireless image communication device 10 is provided separately from the image device, the wireless image communication device 10 may be configured to have an integrated image port 19a, which is connected to an additional external image device (for example, a camera or a camcorder) such that an image signal is input to the wireless image communication device 10 through the integrated image port 19a.

In addition, the wireless image communication device 10 may be integrated with the image device. That is, the wireless image communication device 10 may be configured to have a photographing module 19b, which is connected to the comparison processing device 11 to photograph an image.

The light emitting unit 13 receives an electrical signal from the comparison processing device 11 and converts the electrical signal into an optical signal to output light.

As the light emitting unit 13, a visible light illumination means using a light emitting device such as a light emitting diode (LED) may be used.

At least one light emitting device may be used in the light emitting unit 13. According to circumstances, a plurality of light emitting devices may be used in the light emitting unit 13.

The light emitting device may be used as illumination, since the light emitting device converts electricity into light. In an LED illumination device using the light emitting device, light at the transmission side is recognized by the reception side. Consequently, it is possible to perform a communication function in addition to a basic illumination function.

Although not shown in the figure, the light emitting unit 13 may have the same structure as an illumination driving unit of a general LED illumination device. For example, the light emitting unit 13 may include a plurality of LED light sources, a controller, a modulation unit, and a light source driving unit.

The light emitting unit 13 includes a light emission processor 14 for converting a series-type electrical signal output from the comparison processing device 11 into a single-wavelength optical signal using a single light wavelength mode and transmitting the optical signal. For this reason, the light emitting unit 13 may be efficiently used to transmit light to a long distance.

The light receiving unit 15 is configured to convert an external optical signal, i.e. an optical signal received from the light emitting unit 13, into an electrical signal to be output as an image.

As the light receiving unit 15, a photo detector or a charge-coupled device, which receives an optical signal, may be used.

Although not shown in the figure, the light receiving unit 15 includes a photoelectric conversion unit, which includes a photo detector or an image sensor, a demodulation unit, and a data processing unit. That is, the photoelectric conversion unit receives data from the light emitting unit 13 and converts the received data into an electrical signal. The demodulation unit demodulates the electrical signal to restore the data received from the light emitting unit 13. The data processing unit processes the image data so as to be adapted to the application to be executed.

The wireless image communication device 10 includes an image display device 17 configured to receive the electrical signal, which has been received and converted by the light receiving unit 15, and to output the image received by the light receiving unit 15.

The image display device 17 may be integrated with the wireless image communication device 10, or may be provided separately from the wireless image communication device 10.

For example, the image display device 17 may be integrated in the wireless image communication device 10 to output an image, as in a general communication device (for example, a mobile communication terminal). Alternatively, the image display device 17 may be provided separately from the wireless image communication device 10 so as to output an image.

The illumination diffusion device 20 performs a function of providing illumination under the water to support the communication of the wireless image communication device 10.

The illumination diffusion device 20 is configured to have a structure that is capable of illuminating underwater areas. The illumination diffusion device 20 may be installed in a ship, etc.

The illumination diffusion device 20 is powered on using illumination electricity for supporting marine works supplied from a ship, etc. For this reason, additional electrical power for underwater communication is not needed, whereby it is possible to reduce the total cost of configuring the system.

The illumination diffusion device 20 is configured to illuminate a communication area between wireless image communication devices 10 when underwater bi-directional wireless communication is performed using the wireless image communication devices 10. That is, when a plurality of different wireless image communication devices 10 performs underwater communication, illumination having higher intensity than the light emitting unit 13 is provided to a communication area between the wireless image communication devices 10. As a result, the luminous intensity of the surroundings is minutely changed. Even when underwater turbidity is high, therefore, it is possible to change luminous intensity using the diffused light from the illumination diffusion device 20.

In the case in which underwater turbidity is high, visible light communication is not satisfactorily performed due to a light-scattering phenomenon. In the present invention, the luminous intensity of the light from the light emitting unit 13 of the wireless image communication devices 10 may be increased through the illumination from the illumination diffusion device 20, whereby it is possible to achieve the linearity of the light. In addition, the light receiving unit 15 may sense small variation in the luminous intensity of the surroundings, whereby it is possible to perform underwater image data communication based on excellent-quality bandwidth.

That is, in the underwater bi-directional wireless image data communication system based on illumination diffusion support with the above-stated construction according to the present invention, the diffused light is illuminated so as to sense an optical signal via a minute change in luminous intensity of the surroundings. Consequently, it is possible to simplify the overall structure of the system and to improve the efficiency of communication of high-quality image data in the state in which underwater turbidity is high.

In addition, according to the present invention, the diffused light is illuminated using the illumination electricity of a ship that works at sea. Consequently, additional electrical power for underwater communication is not needed, whereby it is possible to reduce the system construction cost.

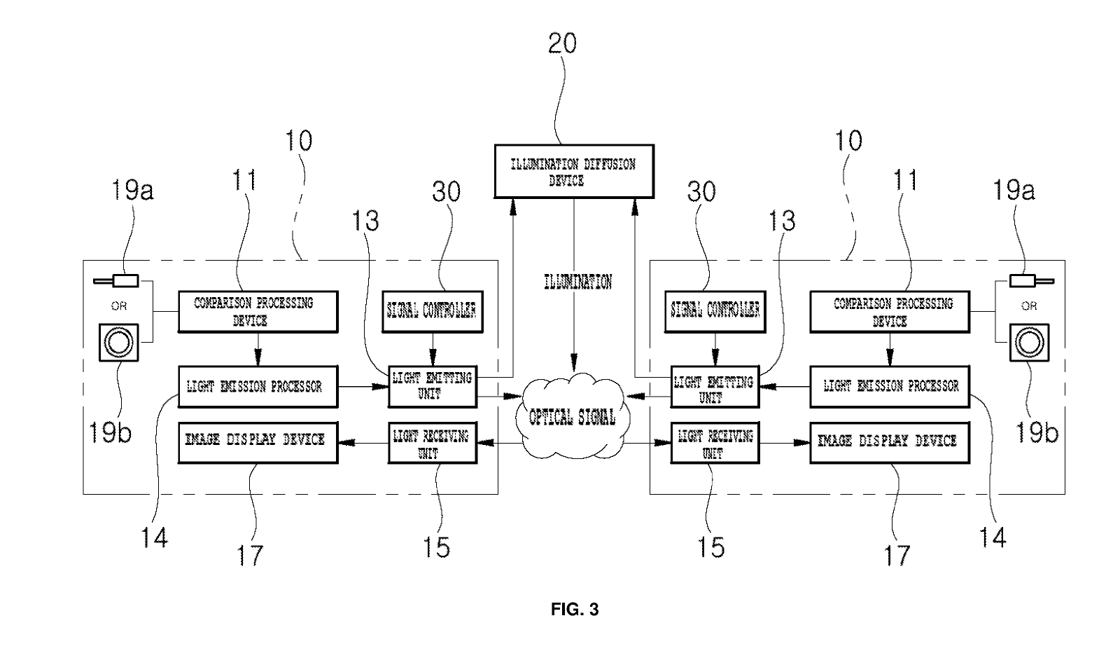

As shown in FIG. 3, another embodiment of the underwater bi-directional wireless image data communication system based on illumination diffusion support according to the present invention further includes a signal controller 30 for, upon receiving a visible light signal during bi-directional communication, controlling the light emitting unit 13 to output an optical signal indicating that the visible light signal has been received to a sender of the visible light signal.

The signal controller 30 is provided in the wireless image communication device 10 to control the light emitting unit 13 depending on whether the light receiving unit 15 has received an optical signal during underwater bi-directional communication. That is, the signal controller 30 controls the light emitting unit 13 to receive an optical signal from another wireless image communication device 10 and to output an optical signal indicating that the optical signal has been received to the another wireless image communication device 10.

The signal controller 30 of the wireless image communication device 10 is configured to control the light emitting unit 13 in order to output an optical signal to the illumination diffusion device 20.

For example, when, after the light emitting unit 13 of one wireless image communication device 10 transmits an optical signal to another wireless image communication device 10, the one wireless image communication device 10 does not receive an optical signal indicating that the optical signal has been received from the another wireless image communication device 10, the signal controller 30 controls the light emitting unit 13 of the one wireless image communication device 10 to output an optical signal for illumination adjustment to the illumination diffusion device 20 such that the illumination diffusion device 20 provides illumination having higher intensity.

According to this embodiment, whether to provide diffused light is controlled depending on whether an optical signal is successfully transmitted and received between the wireless image communication devices 10, whereby it is possible to minimize power consumption, thereby optimizing energy consumption.

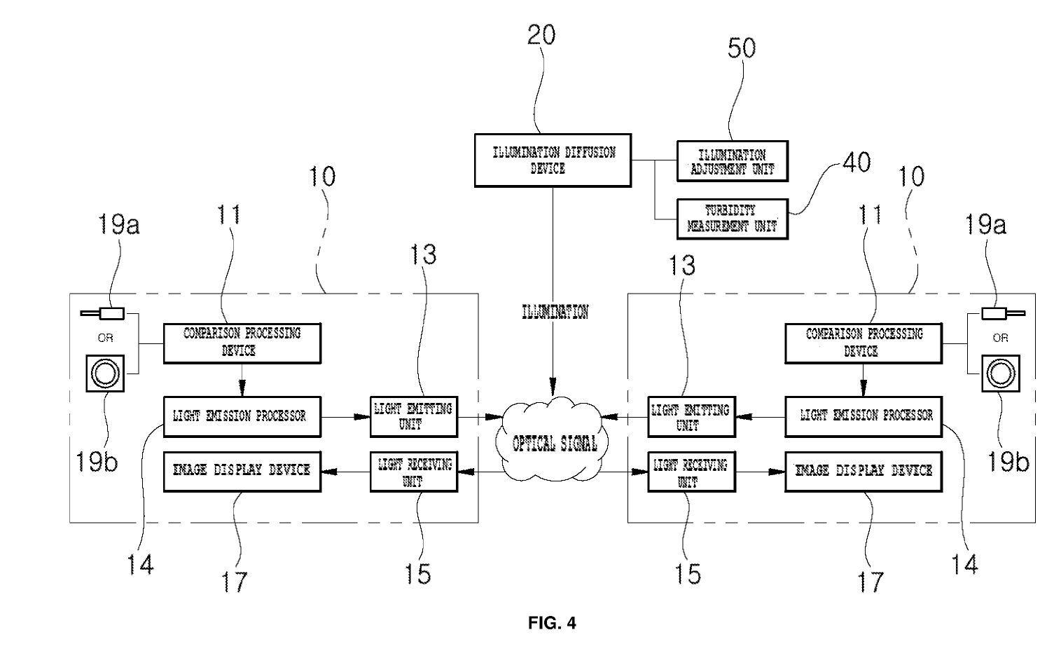

As shown in FIG. 4, a further embodiment of the underwater bi-directional wireless image data communication system based on illumination diffusion support according to the present invention further includes a turbidity measurement unit 40 mounted to the illumination diffusion device 20 for measuring underwater turbidity.

The turbidity measurement unit 40 is identical in construction to a general turbidity meter or a general turbidity measuring instrument, and therefore a detailed description thereof will be omitted.

The illumination diffusion device 20 includes an illumination adjustment unit 50 for adjusting the intensity of illumination based on turbidity measured by the turbidity measurement unit 40. For example, in the case in which the turbidity measured by the turbidity measurement unit 40 is equal to or greater than a reference value, the intensity of illumination output from the illumination diffusion device 20 is controlled by the illumination adjustment unit 50.

According to this embodiment, underwater turbidity is measured to adjust the intensity of diffused light. Consequently, it is possible to further improve communication performance based on underwater visible light communication while maximally extending the lifespan of the illumination device.

The other elements of the embodiments shown in FIGS. 3 and 4, excluding the above-described elements, are identical to those of the embodiment shown in FIGS. 1 and 2, and therefore a detailed description thereof will be omitted.

As apparent from the above description, in the underwater bi-directional wireless image data communication system based on illumination diffusion support according to the present invention, the diffused light is illuminated so as to sense an optical signal via a minute change in the luminous intensity of the surroundings. Consequently, it is possible to simplify the overall structure of the system and to improve the efficiency of communication of high-quality image data in the state in which underwater turbidity is high.

In addition, in the underwater bi-directional wireless image data communication system based on illumination diffusion support according to the present invention, the diffused light is illuminated using the illumination electricity of a ship that works at sea. Consequently, additional electrical power for underwater communication is not needed, whereby it is possible to reduce system construction cost.

In addition, in the underwater bi-directional wireless image data communication system based on illumination diffusion support according to the present invention, whether to provide diffused light is controlled depending on whether an optical signal is successfully transmitted and received between the wireless image communication devices, whereby it is possible to minimize power consumption, thereby optimizing energy consumption.

In addition, in the underwater bi-directional wireless image data communication system based on illumination diffusion support according to the present invention, underwater turbidity is measured and the intensity of diffused light is adjusted in consideration thereof. Consequently, it is possible to further improve communication performance based on underwater visible light communication while maximally extending the lifespan of the illumination device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An underwater bi-directional wireless image data communication system based on illumination diffusion support comprising:
a wireless image communication device comprising a comparison processing device for converting an image signal about image data photographed by an image device or input from the image device into an electrical signal, a light emitting unit for receiving the electrical signal from the comparison processing device and converting the electrical signal into an optical signal to output light, and a light receiving unit for receiving an external optical signal and converting the external optical signal into an electrical signal to be output as an image; and
an illumination diffusion device for providing illumination having higher intensity than illumination of the light emitting unit to a communication area between wireless image communication devices when underwater bi-directional wireless communication is performed using the wireless image communication devices.

2. The underwater bi-directional wireless image data communication system according to claim 1, wherein the wireless image communication device is provided separately from the image device, and wherein the wireless image communication device comprises an integrated image port, which is connected to an external image device such that an image signal is input to the wireless image communication device through the integrated image port.

3. The underwater bi-directional wireless image data communication system according to claim 1, wherein the wireless image communication device is integrated with the image device, and wherein the wireless image communication device comprises a photographing module connected to the comparison processing device for photographing an image.

4. The underwater bi-directional wireless image data communication system according to claim 1, wherein the wireless image communication device comprises an image display device for receiving the electrical signal, which has been received and converted by the light receiving unit and outputting the image received by the light receiving unit.

5. The underwater bi-directional wireless image data communication system according to claim 4, wherein the image display device is integrated with the wireless image communication device or is provided separately from the wireless image communication device.

6. The underwater bi-directional wireless image data communication system according to claim 1, wherein the light emitting unit comprises a light emission processor for converting a series-type electrical signal output from the comparison processing device into a single-wavelength optical signal and transmitting the optical signal.

7. The underwater bi-directional wireless image data communication system according to claim 1, wherein the wireless image communication device further comprises a signal controller for, when the light receiving unit receives an optical signal during underwater bi-directional wireless communication, controlling the light emitting unit to output an optical signal indicating that the optical signal has been received to another wireless image communication device.

8. The underwater bi-directional wireless image data communication system according to claim 7, wherein, when, after the light emitting unit transmits an optical signal to the another wireless image communication device, the wireless image communication device does not receive an optical signal indicating that the optical signal has been received from the another wireless image communication device, the signal controller controls the light emitting unit to output an optical signal for illumination adjustment to the illumination diffusion device.

9. The underwater bi-directional wireless image data communication system according to claim 1, further comprising:
a turbidity measurement unit mounted to the illumination diffusion device for measuring underwater turbidity, wherein
the illumination diffusion device comprises an illumination adjustment unit for adjusting intensity of illumination based on the underwater turbidity measured by the turbidity measurement unit.
